(19) United States
(12) Patent Application Publication
(10) Pub. No.: US 2026/0254146 A1
(43) Pub. Date: Aug. 27, 2026

(54) POWER CONNECTOR WITH IMPROVED TERMINAL ASSEMBLIES

(71) Applicant: FOXCONN INTERCONNECT TECHNOLOGY LIMITED, Grand Cayman (KY)

(72) Inventor: YUNG-CHIH HUNG, New Taipei (TW)

(21) Appl. No.: 19/529,631

(22) Filed: Feb. 4, 2026

(30) Foreign Application Priority Data
Feb. 24, 2025 (CN) 202510203385.X

(51) Int. Cl. H01R 13/24; H01R 13/187; H01R 13/405; H01R 13/46; H01R 25/14

(52) U.S. Cl. CPC H01R 13/2457; H01R 13/187; H01R 13/405; H01R 13/46; H01R 25/142; H01R 25/145

(57) ABSTRACT

A power connector includes: an insulating housing having a mating slot and two passages behind the mating slot; two power terminals each includes a retained portion fixed in the corresponding passage and plural elastic arms extending forward from the retained portion, the elastic arms have contacting portions protruding into the mating slot; and two reinforcing plates attached to the power terminals respectively; wherein each of the reinforcing plates includes an additional retained portion and plural additional elastic arms extending forwards from the additional retained portion, the additional retained portion is fixed between the retained portion and the passage, and the additional elastic arms have additional contacting portions protruding into the mating slot.

### BACKGROUND OF THE INVENTION

### 1. Field of the Invention

The present invention relates to a power connector with improved terminal assemblies.

### 2. Description of Related Arts

U.S. Patent No. 11,837,825 discloses a connector including two terminal assemblies arranged opposite to and spaced apart. Each of terminal assemblies has a plate-shaped fixing portion, a terminal portion, and a laterally extending connection portion to connect the plate-shaped fixing portion and the terminal portion. A spacing between the plate-shaped fixing portions is greater than a spacing between the terminal portions. A conductive block is laminated on an inner surface of the terminal portion of each of the terminal assemblies.

An improved power connector is desired.

### SUMMARY OF THE INVENTION

An object of the present invention is to provide a power connector with improved terminal assemblies.

To achieve the above-mentioned object, a power connector comprises: an insulating housing having a mating slot and two passages behind the mating slot; two power terminals each comprising a retained portion fixed in the corresponding passage and a plurality of elastic arms extending forward from the retained portion, the elastic arms having contacting portions protruding into the mating slot; and two reinforcing plates attached to the power terminals respectively; wherein each of the reinforcing plates comprises an additional retained portion and a plurality of additional elastic arms extending forwards from the additional retained portion, the additional retained portion is fixed between the retained portion and the passage, and the additional elastic arms have additional contacting portions protruding into the mating slot.

Other advantages and novel features of the invention will become more apparent from the following detailed description of the present embodiment when taken in conjunction with the accompanying drawings.

### BRIEF DESCRIPTION OF DRAWINGS

FIG. 1 is a top plane view of a power connector and a power plug in a mated state according to one embodiment of the present application;

FIG. 2 is a perspective view of the power connector in FIG. 1;

FIG. 3 is a cross-sectional view of the power connector taken along a broken line A-A in FIG. 2;

FIG. 4 is a perspective view of an insulating housing in FIG. 2;

FIG. 5 is a perspective view of a first piece of the power terminal in FIG. 2;

FIG. 6 is a perspective view of a second piece of the power terminal in FIG. 2;

FIG. 7 is a perspective view of a reinforcing plate in FIG. 2;

FIG. 8 is a perspective view of the reinforcing plate and two copper pins in FIG. 7;

FIG. 9 is a perspective view of a power assembly in FIG. 2;

FIG. 10 is a perspective view of two grounding members in FIG. 2;

FIG. 11 is a perspective view of the power plug in FIG. 1;

FIG. 12 is another perspective view of the power plug in FIG. 11; and

FIG. 13 is a sectional perspective view of the power plug in FIG. 11 without a fixing frame.

### DETAILED DESCRIPTION OF THE PREFERRED EMBODIMENT

Reference will now be made to the drawing figures to describe a preferred embodiment of the present invention in detail.

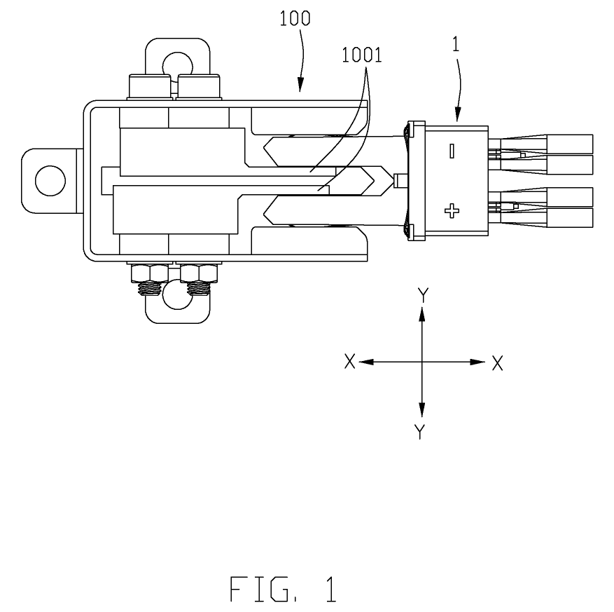

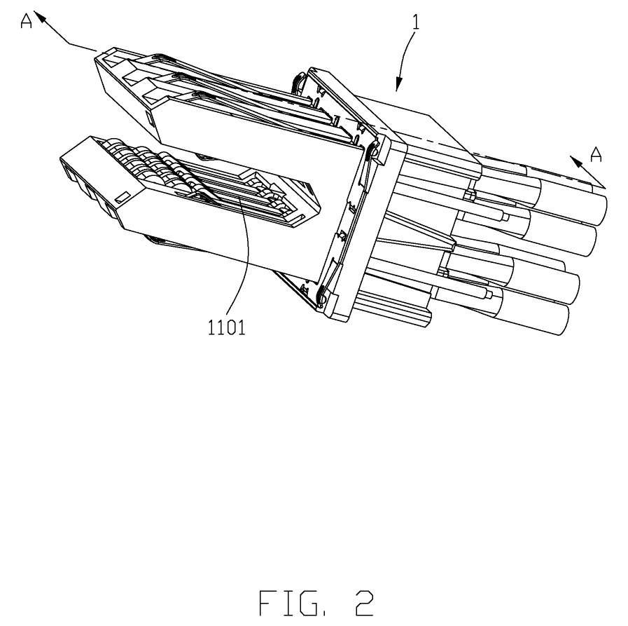

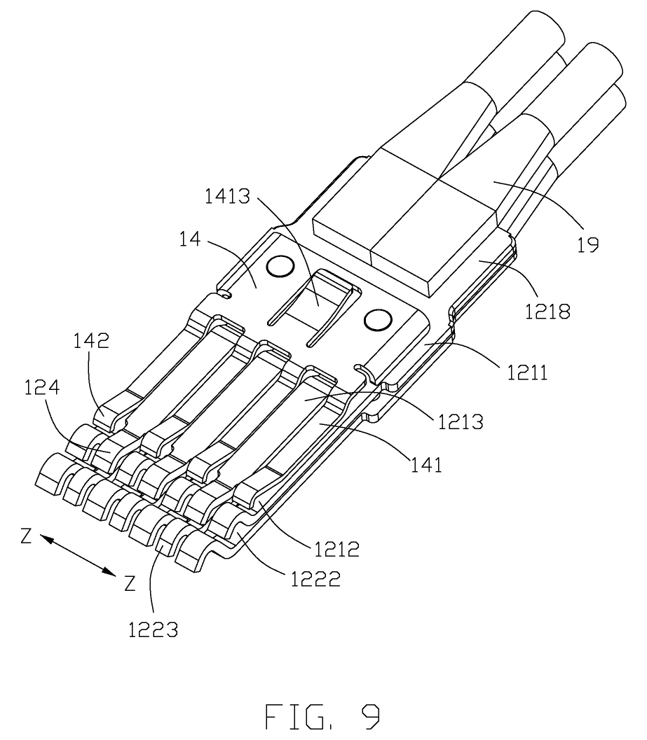

Referring to FIG. 1, a power connector 1 and a power plug 100 are mated with each other in a mating direction X-X, of an embodiment of this invention. Refer to FIGS. 2-4, the power connector 1 includes an insulating housing 11 and two power terminals 12. The insulating housing 11 has a mating slot 1101 opening forwards in the mating direction X-X and two receiving passages or passages 1102 located behind the mating slot 1101 in the mating direction and at opposite sides of the mating slot in a first direction Y-Y. The two power terminals 12 are fixed in the passages 1102 respectively and extend rearwards out of the passages 1102. Combination with FIG. 9, each of the power terminals 12 comprises a retained portion 121a fixed in the passage 1102 and a plurality of elastic arms 121b extending forward from the retained portion 121a, and the plurality of elastic arms 121b has contacting portions 121c protruding into the mating slot 1101 in the first direction Y-Y. Connecting portions 121d, i.e., the soldering portion 1218, 1228 extend rearwards from the retained portion 121a and is connected to a power cable 19 or a power bus bar. In this embodiment, each of the power terminals 12 includes two pieces, i.e., a first piece 121 and a second piece 122. Alternatively, each of the power terminals only includes one piece 121.

Each of the power terminals 12 further includes a reinforcing plate 14 fixed between the retained portion 121a and the passage 1102. The reinforcing plate 14 further extends a plurality of additional elastic arms 141 having additional contacting portions 142 protruding into the mating slot 1101. In this embodiment, the two power terminals 12 have a substantially same structure, and one may be a positive terminal and another may be a negative terminal. The power terminal 12 and the reinforcing plate 14 are conductive. The reinforcing plate 14 not only assist to retain the power terminal 12 in the insulating housing 11, but also offer a current path so as to reduce induction and heat generation of the whole terminal power 12.

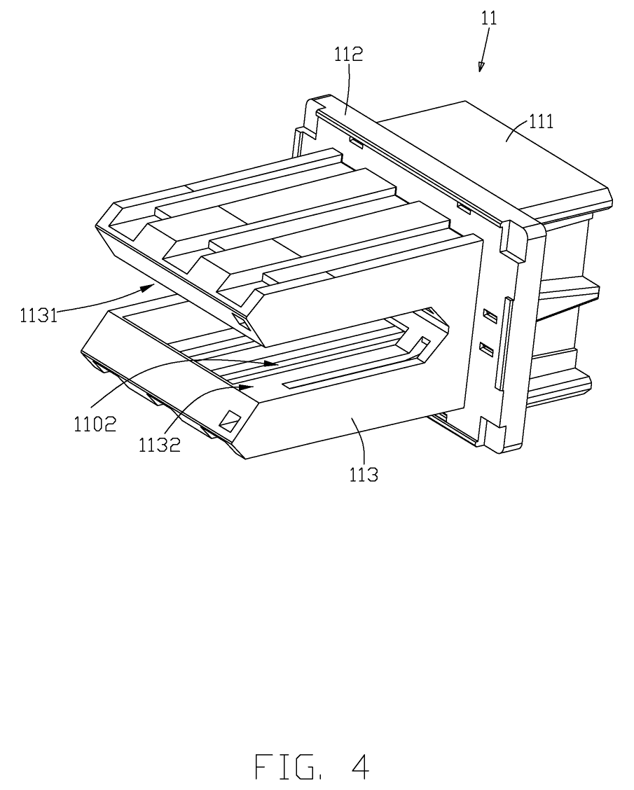

Referring to FIG. 4, the insulating housing 11 may include a first inside 1131 and a second inside 1132 at opposite sides of the mating slot 1101 in the first direction Y-Y. The power terminals 12 are respectively disposed on the first inside 1131 and the second inside 1132. The outer face of the reinforcing plate 14 is fixed to the retained portion 121a, and the inner face of the reinforcing plate 14 is engaged with the side of the passage 1102. The insulating housing 11 includes a partition portion 112, a base portion 111 extending rearwards from the partition portion 112, a mating portion 113 extend forward from the partition portion 111. The first inside 1131 and the second inside 1132 are located at opposite sides of the mating slot 1101.

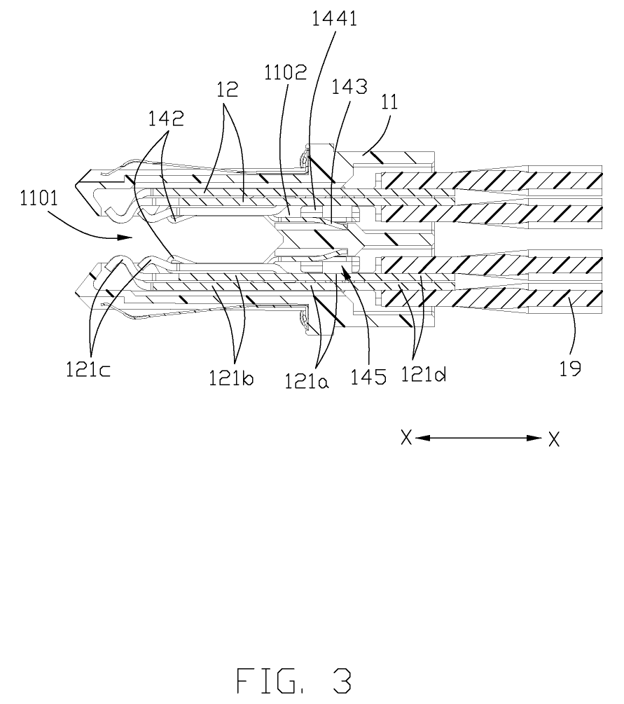

Referring to FIGS. 3-5, each of the power terminals 12 includes the first piece 121. The first piece 121 includes plural first elastic arms 1212 and second elastic arms 1213 extending forwards from the first retained portion 1211. The first elastic arms 1212 and the second elastic arms 1213 are alternately arranged in a second direction Z-Z, and the second elastic arms 1213 are positioned closer to the mating slot 1101 than the first elastic arms 1212 in the first direction Y-Y. The mating direction X-X, the first direction Y-Y and the second direction Z-Z are perpendicular to each other. The first elastic arms 1212 and the first retained portion 1211 are located on the same plane, while the second elastic arms 1213 are offset from the retained portion 1211. Referring to FIG. 9, the second elastic arm 1213 is located between two adjacent additional elastic arms 141 in the second direction Z-Z.

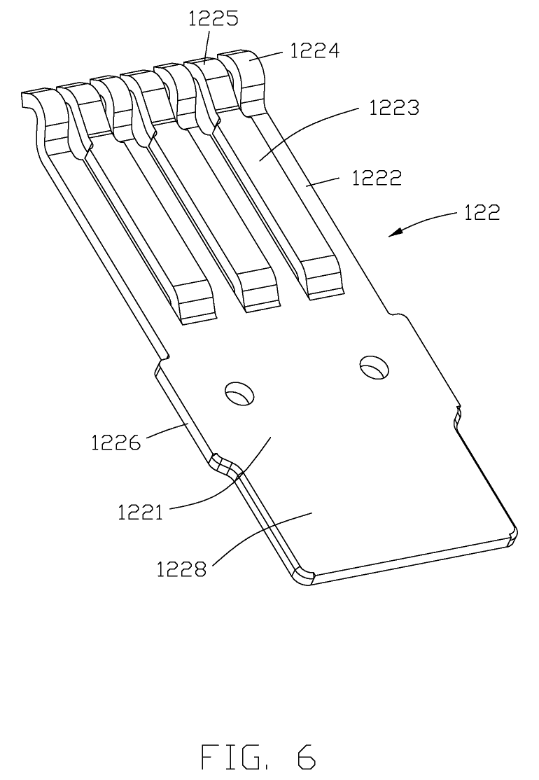

Referring to FIGS. 3 and 6, each of the power terminals 12 further includes a second piece 122 stacked on an outside of the first piece 121 in the first direction. The second piece 122 includes plural third elastic arms 1222 and fourth elastic arms 1223. The third elastic arms 1222 and the fourth elastic arms 1223 are alternately arranged in the second direction Z-Z and the fourth elastic arms 1223 are positioned closer to the mating slot 1101 than the third elastic arms 1222 in the first direction. The third elastic arms 1222 and the retained portion 1221 are located at the same plane, while the fourth elastic arms 1223 are offset from the retained portion 1221. Preferably, there is no gap or only a very small gap between the first elastic arms 1212 and the second elastic arms 1213, such that no other elastic arms can be arranged therebetween. Similarly, there is no gap or only a very small gap between the third elastic arms 1222 and the fourth elastic arms 1223, such that no other elastic arms can be arranged therebetween. In other embodiments, the power terminal may only have the first piece 121 and the reinforcing plate 14, or may have plural pieces and the reinforcing plate 14.

The first to the fourth arms are defined as the elastic arms 121b in this embodiment. The first elastic arms 1212 have contacting portions 1214, the second elastic arms 1213 have contacting portions 1215, the third elastic arms 1222 have contacting portions 1224, and the fourth elastic arms 1223 have contacting portions 1225. Those contacting portions are defined as the contacting portions 121c. Those contacting portions can form parallel contact points, so as to allow power current to be distributed during transmission, thereby reducing the power current load on a single contact point and lowering local temperature rise. In addition, when the contacting portions contact the conductor 1001 of the power plug 100, the concentrated pressure can break the oxide layer on the conductor itself and/or on the conductor of the power plug 100, thereby reducing contact resistance. At the same time, the contacting portions can self-adjust for slight displacement, maintain constant pressure, and suppress regeneration of the oxide layer. The additional contacting portions 142 are located behind the contacting portions 121c in the mating direction X-X. The contacting portions of the third elastic arms and the fourth elastic arms are arranged in a row, and the contacting portions of the first elastic arms and the second elastic arms are arranged in a row and are located between the additional contacting portions and the contacting portions of the first elastic arms in the mating direction X-X.

The first piece 121 and the second piece 122 have a plural of contacting points 1217. Therefore, the terminal enables high pressure to break through the oxide layer and form multiple parallel current paths, thereby reducing the contact resistance to one-tenth or even lower compared to surface contact, and improve the reliability and heat dissipation capability of the first piece 121 and the second piece 122.

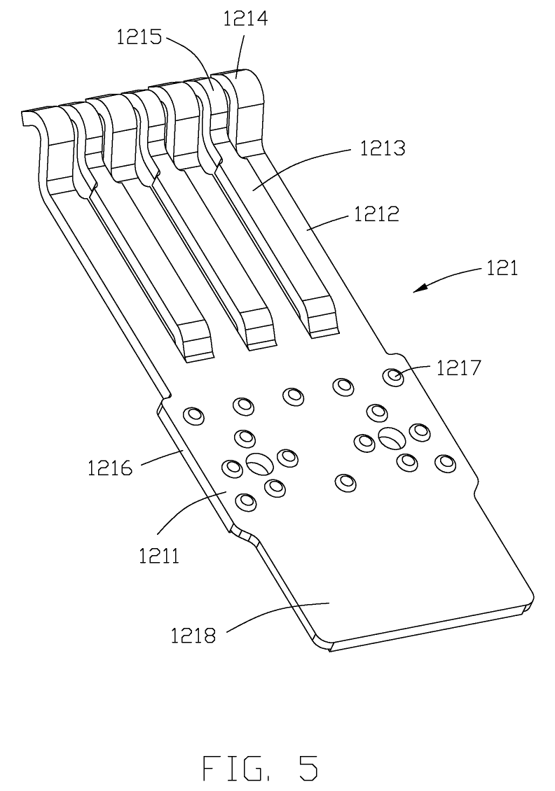

Referring to FIG. 5, the first piece 121 has an interfaced protrusion 1216 at opposite sides of the retaining portion 1211 thereof, and the second piece 122 has an interfaced protrusion 1226 at opposite sides of the retaining portion 1221 thereof. The interfaced protrusion 1216, 1226 are fixed within the passage 1102 by means of hard interference, thereby securing the power terminal in the insulating housing 11.

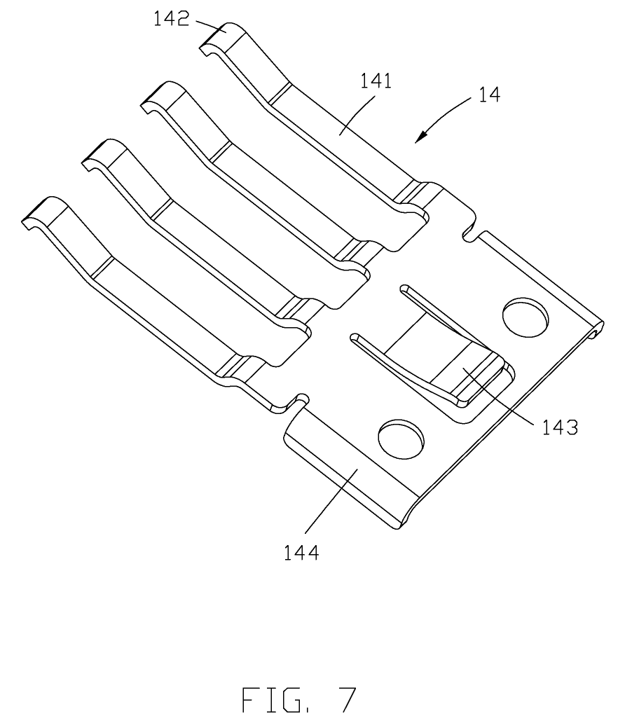

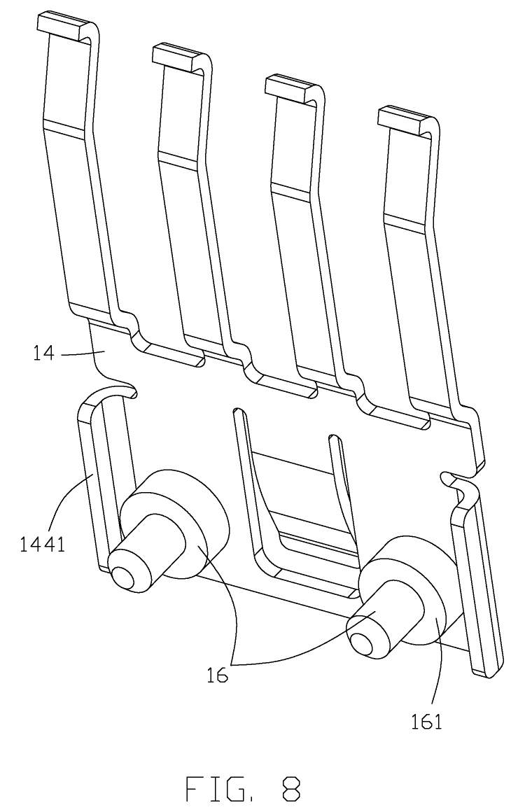

Referring to FIGS. 7-8, each reinforcing plate 14 has an additional retained portion 144 and at least one abutting tab 143 punched from the additional retained portion 144. The additional elastic arms 141 extend from the additional retained portion. The abutting tab 143 extends rearward in an inclined manner and abuts rearwards against the insulating housing 11, thereby preventing the power terminal from disengaging rearward from the insulating housing 11. The he additional retained portion 144 is of a U shape, i.e., with two bending portion 1441 as shown in FIG. 8, and is fixed with the retained portions 1211, 1221 of the first and second pieces. The abutting tab 143 extends from the additional retained portion 144. The abutting tab 143 extends rearward and slantwise abuts rearwards against a face of the passage and located just behind the mating slot in the mating direction as shown in FIG. 3.

Referring to FIG. 3, a gap 145 is defined between the additional retained portion 144 and the retained portion 1211 to improve the reliability of the power terminal 12. Improving reliability may include compensating for thermal expansion and mechanical deformation, reducing fretting wear, optimizing contact pressure distribution, and enhancing assembly tolerance. Specifically, the additional retained portion 144 bends and abut against the retained portion 1211 of the first piece, thereby forming the aforementioned gap 145.

Referring to FIG. 8, the reinforcing plate 14 can secure the power terminal 12 to the first inside 1131 or the second inside 1132 by means of a copper pin 16. Moreover, the contact area between the copper pins 16 and the reinforcing plate 14 is greater than the contact area between the copper pins 16 and the positive terminal 12. In this case, the copper pins 16 can reduce the contact resistance when the reinforcing plate 14 and the power terminal 12 are connected, as well as when all three are in contact simultaneously. The copper pin 16 has two supporting face 161 to support the additional retained portion 144 and the retained portion 1211 to keep the gap 145.

Preferably, the soldering portions 1218, 1228 of the power terminal 12 is connected to the power cable 19, while the reinforcing plate 14 has no such connecting portion which is used to be connected with any conductive element, such as power cable. Referring to FIG. 3, the power cable 19 can be connected to the corresponding power terminal to deliver current, and the power cable 19 can be arranged in the base portion 111 of the insulating housing 11. There may be plural power cables 19. For example, the power cables 19 connected to one power terminal 12 may include an input wire, a 200-amp input wire, a 250-amp input wire, and a 300-amp input wire. The power cables 19 connected to the other power terminal may include an output wire, a 200-amp output wire, a 250-amp output wire, and a 300-amp output wire.

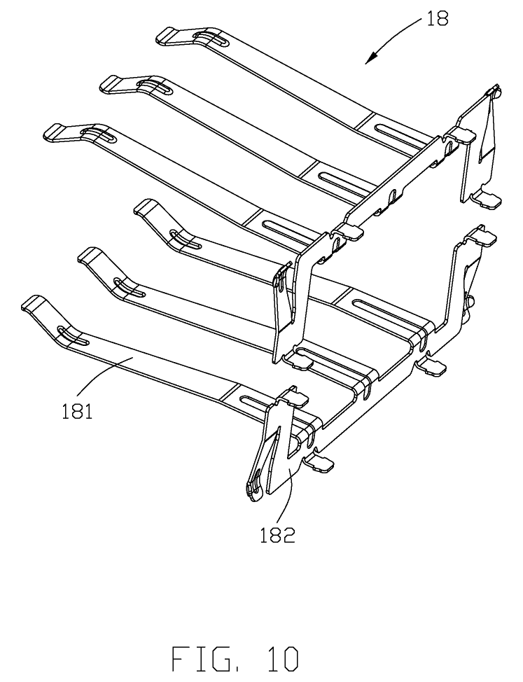

Referring to FIGS. 3 and 10, two grounding members 18 are disposed on the outsides of the mating portion 112 opposite to the mating slot 1101. The grounding members 18 includes elastic fingers 181 extend in the mating direction X-X, and a mounting portion 182 attached on the front face of the partition portion 1111. The elastic fingers apply a reactive force to the power plug 100 when the power connector 1 is mated with the power plug 100, thereby establish a ground path therebetween.

The two power terminals 12 are arranged symmetrically, and the two reinforcing plates 14 are also arranged symmetrically. That is, the shapes and sizes of the two power terminals may be the same or similar, but the installation directions are opposite. Likewise, the shapes and sizes of the two reinforcing plates 14 may also be the same or similar, but the installation directions are opposite.

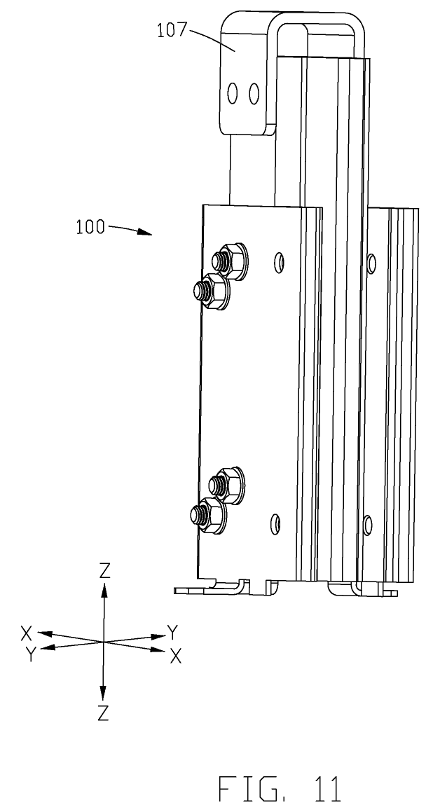

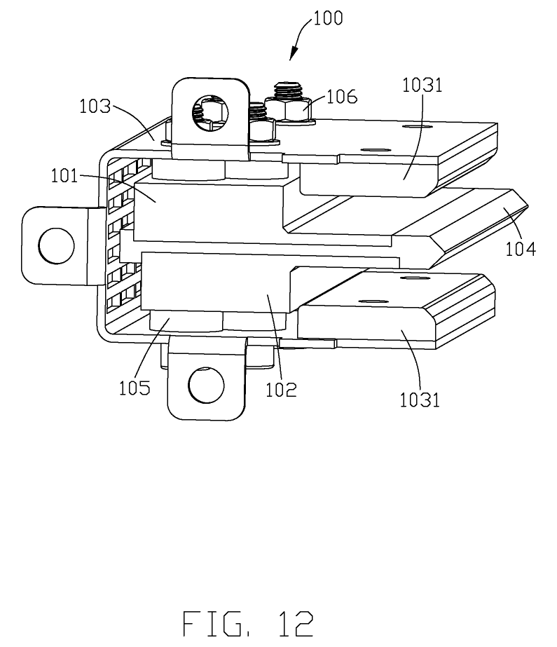

Referring to FIGS. 11-12, the power plug 100 includes a fixing frame 103, a first insulating member 104, and two conductive bus bars, one is the positive bus bar 101 and another is the negative bus bar 102. The two bus bars are respectively embedded on opposite sides of the first insulating member 104, and the first insulating member 104 is fixed to the fixing frame 103. When the power plug 100 is mated with the power connector 1, the bus bars 101, 102 contact the contacting portions 121c and the additional contacting portions 142 of two power terminals. The fixing frame 103 is made of a copper, and has a U-shape. Copper blocks 1031 are disposed on the inner sides of the fixing frame 103. The first insulating member 104 has a front taper portion for guiding, in front of the two bus bars.

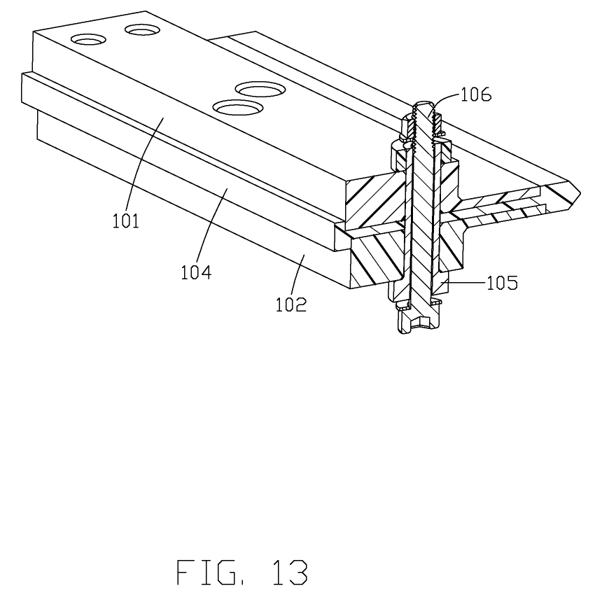

Referring to FIG. 13, the power plug 100 further includes a second insulating member 105. The bus bars are fixed to the fixing frame 103 by screws 106, and the second insulating member 105 is sleeved onto the screws 106 to insulate the bus bars from the screws 106. Therefore, the copper fixing frame 103 can efficiently dissipate heat without affecting the current transmission of the positive bus bar 101 and the negative bus bar 102.

Referring also to FIG. 11, the power plug 100 further includes a connecting member 107 made of a copper profile. The connecting member 107 is used to connect the top ends of the bus bars.

The additional elastic arms 141 of the reinforcing plate are correspondingly located in the gaps formed by the elastic arms of the power terminal. The reinforcing plate 14 forms a current-carrying path, which not only creates more current channels within a limited space to reduce heating issues when the current increases, but also helps to avoid structural complexity and cost problems caused by excessive stacking of terminals.

The above-mentioned embodiments are only preferred embodiments of the present invention, and should not limit the scope of the present invention, any simple equivalent changes and modifications made according to the claims of the present invention and the contents of the description should still belong to the present invention.

1. A power connector comprising:an insulating housing having a mating slot and two passages behind the mating slot;two power terminals each comprising a retained portion fixed in a corresponding passage and a plurality of elastic arms extending forward from the retained portion, the elastic arms having contacting portions protruding into the mating slot; andtwo reinforcing plates attached to the power terminals respectively;wherein each of the reinforcing plates comprises an additional retained portion and a plurality of additional elastic arms extending forwards from the additional retained portion, the additional retained portion is fixed between the retained portion and the passage, and the additional elastic arms have additional contacting portions protruding into the mating slot.

2. The power connector as claimed in claim 1, wherein the additional retained portion has at least one abutting tab punched therefrom, and the abutting tab extends rearward in an inclined manner and abuts rearwards against the insulating housing.

3. The power connector as claimed in claim 2, wherein the additional retained portion bends and abuts against the retained portion to form a gap between the additional retained portion and the retained portion.

4. The power connector as claimed in claim 2, wherein the additional retained
portion and the retained portion are fitly retained by two copper pins, and the copper pins have supporting faces supporting the additional retained portion and the retained portion to keep a gap therebetween.

5. The power connector as claimed in claim 1, wherein the power terminal comprises a connecting portion extending rearwards from the retaining portion, a power cable or a power conductive plate is attached to the connecting portion, and the reinforcing plate has no connecting portion behind the retained portion.

6. The power connector as claimed in claim 1, wherein the power terminal comprises a first piece comprising a plurality of first elastic arms and a plurality of second elastic arms, the first elastic arms and the second elastic arms are alternately arranged with each other and the second elastic arms are closer to the mating slot than the first elastic arms, and the second elastic arms are located between two adjacent additional elastic arms.

7. The power connector as claimed in claim 6, wherein the power terminal comprises a second piece stacked on an outer side of the first piece, the second piece comprises a plurality of third elastic arms and a plurality of fourth elastic arms alternately arranged with each other, and the fourth elastic arms are closer to the mating slot than the third elastic arms.

8. The power connector as claimed in claim 7, wherein the additional retained portion is attached to an inside of the first piece.

9. A power connector comprising:
an insulating housing defining a mating direction and having a mating slot opening forwards and two passages behind the mating slot in the mating direction, the two passages being located at opposite sides of the mating slot in a first direction perpendicular to the mating direction;
two power terminals received in the passages respectively, each of the power terminals comprising a retained portion fixed in the passage and a plurality of elastic arms extending forward from the retained portion and arranged in a second direction perpendicular to the first direction and the mating direction, the elastic arms having contacting portions protruding into the mating slot in the first direction; and
two reinforcing plates attached to the power terminals respectively;
wherein each of the reinforce plates comprises an additional retained portion fitly attached to the retained portion and at least one abutting tab punched from the additional retained portion, and the at least one abutting tab extends rearward and slantwise abuts rearwards against a face of the passage and is located just behind the mating slot in the mating direction.

10. The power connector as claimed in claim 9, wherein the reinforcing plate comprises a plurality of additional elastic arms extending from the additional retained portion, and the additional elastic arms have contacting portions protruding into the mating slot.

11. The power connector as claimed in claim 9, wherein the additional retaining portion and the retained portion are retained by two copper pins and are separated by a gap in the first direction.

12. The power connector as claimed in claim 9, wherein the abutting tab is located between the copper pins in the second direction.

13. The power connector as claimed in claim 12, wherein each of the copper pin has two supporting faces abutting against the additional retaining portion and the retained portion respectively to keep the gap.

14. The power connector as claimed in claim 9, wherein opposite sides of the additional retaining portion in the second direction bend and abut against the retaining portion in the first direction to keep a gap between the additional retained portion and the retained portion.

15. The power connector as claimed in claim 9, wherein:the power terminal comprises a first piece and a second piece;the first piece comprises a plurality of first elastic arms and a plurality of second elastic arms, the first elastic arms and the second elastic arms are alternately arranged with each other and the second elastic arms are closer to the mating slot than the first elastic arms, and the additional elastic arms are located between two adjacent second elastic arms; andthe second piece is stacked on an outer side of the first piece, the second piece comprises a plurality of third elastic arms and a plurality of fourth elastic arms alternately arranged with each other and the fourth elastic arms are closer to the mating slot than the third elastic arms, and the first elastic arms are located in between two adjacent fourth elastic arms.
